(19) United States
(12) Patent Application Publication
(10) Pub. No.: US 2015/0349623 A1
(43) Pub. Date: Dec. 3, 2015

(54) INVERTER GATE BOARD

(71) Applicant: Hyundai Motor Company, Seoul (KR)

(72) Inventors: Ki Jong Lee, Osan (KR); Tae Hwan Chung, Incheon (KR); Kang Ho Jeong, Changwon (KR)

(21) Appl. No.: 14/527,363

(22) Filed: Oct. 29, 2014

(30) Foreign Application Priority Data
Jun. 3, 2014 (KR) 10-2014-0067877

(51) Int. Cl. H02M 1/088; H02M 7/539

(52) U.S. Cl. CPC H02M 1/088; H02M 7/539

(57) ABSTRACT

An inverter gate board divided into a low-voltage region and a high-voltage region includes a plurality of drive circuits surface-mounted between the low-voltage region and the high-voltage region, each having a single main power source (SMPS) controller, and a plurality of transformers surface-mounted between the low-voltage region and the high-voltage region so as to supply a transformed voltage to each of the plurality of drive circuits, respectively.

### CROSS REFERENCE TO RELATED APPLICATION

The present application claims priority to and the benefit of Korean Patent Application Number 10-2014-0067877 filed on Jun. 3, 2014, the entire contents of which are incorporated herein for all purposes by reference.

### BACKGROUND

1. Technical Field

The present disclosure relates, in general, to an inverter gate board which is divided into a high-voltage region and a low-voltage region and is provided with a plurality of drive circuits surface-mounted between the high-voltage region and the low-voltage region to individually drive a plurality of power modules.

2. Description of the Related Art

Generally, an inverter is composed of a plurality of insulated-gate bipolar transistors (IGBTs) and supplies three-phase power to a motor. An IGBT of an inverter is operated by a gate drive circuit to supply a gate signal. In the related art, if two motors are provided, two inverter gate boards are typically mounted and operated such that a single main power source (SMPS) supplies gate power to a plurality of IGBTs.

The inverter gate board is provided with a low-voltage battery region and a high-voltage battery region. According to the related art, a transformer is typically mounted in the low-voltage region of the inverter gate board and serves to transform a voltage supplied from a single main power source and supply the transformed voltage to a plurality of drive circuits to drive the IGBTs in correspondence with respective phases.

Here, since the transformer is mounted in the low-voltage region, a high-voltage trace exists in the low-voltage region, thereby causing problems in that usage area of the low-voltage region is reduced, while insulation between the high-voltage region and the low-voltage region must be secured. Further, since one transformer can supply drive voltages in correspondence with six phases, for example, a power source terminal is problematically heated.

The foregoing is intended merely to aid in the understanding of the background of the present disclosure, and is not intended to mean that the present disclosure falls within the purview of the related art that is already known to those skilled in the art.

### SUMMARY

Accordingly, the present disclosure has been made keeping in mind the above problems occurring in the related art, and the present disclosure is intended to propose an inverter gate board in which transformers are respectively mounted to drive circuits mounted between a high-voltage region and a low-voltage region, thereby improving insulating stability.

In order to achieve the above object, according to one aspect, the present disclosure provides an inverter gate board divided into a low-voltage region and a high-voltage region, the inverter gate board including: a plurality of drive circuits surface-mounted between the low-voltage region and the high-voltage region and each having a single main power source (SMPS) controller; and a plurality of transformers surface-mounted between the low-voltage region and the high-voltage region so as to supply a transformed voltage to each of the plurality of drive circuits, respectively.

The plurality of drive circuits may supply a gate power to individual power modules. The inverter gate board may further include a controller surface-mounted to the high-voltage region and communicating with the plurality of drive circuits and a control board, wherein the plurality of drive circuits receive information from the individual power modules and transmit the information to the controller. The inverter gate board may further include an optical coupler to insulate the controller from the low-voltage region.

### BRIEF DESCRIPTION OF THE DRAWINGS

The above and other objects, features and advantages of the present disclosure will be more clearly understood from the following detailed description when taken in conjunction with the accompanying drawings, in which:

FIG. 1 is a schematic view showing an inverter gate board according to an embodiment of the present disclosure; and

FIG. 2 is a block diagram showing a connection of the inverter gate board with an external board and modules according to an embodiment of the present disclosure.

### DETAILED DESCRIPTION OF THE EMBODIMENTS

Specific structural and functional descriptions of embodiments of the present disclosure disclosed herein are only for illustrative purposes of the embodiments of the present disclosure. The present disclosure may be embodied in many different forms without departing from the spirit and significant characteristics of the present disclosure. Therefore, the embodiments of the present disclosure are disclosed only for illustrative purposes and should not be construed as limiting the present disclosure.

Reference will now be made in detail to various embodiments of the present disclosure, specific examples of which are illustrated in the accompanying drawings and described below, since the embodiments of the present disclosure can be variously modified in many different forms. While the present disclosure will be described in conjunction with exemplary embodiments thereof, it is to be understood that the present description is not intended to limit the present disclosure to those exemplary embodiments. On the contrary, the present disclosure is intended to cover not only the exemplary embodiments, but also various alternatives, modifications, equivalents and other embodiments that may be included within the spirit and scope of the present disclosure as defined by the appended claims.

It will be understood that, although the terms “first,” “second,” etc. may be used herein to describe various elements, these elements should not be limited by these terms. These terms are only used to distinguish one element from another element. For instance, a first element discussed below could be termed a second element without departing from the teachings of the present disclosure. Similarly, the second element could also be termed the first element.

It will be understood that when an element is referred to as being “coupled” or “connected” to another element, it can be directly coupled or connected to the other element or intervening elements may be present therebetween. In contrast, it should be understood that when an element is referred to as being “directly coupled” or “directly connected” to another element, there are no intervening elements present. Other expressions that explain the relationship between elements, such as “between,” “directly between,” “adjacent to,” or “directly adjacent to,” should be construed in the same way.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Additionally, it is understood that the below methods may be executed by at least one controller, The term “controller” refers to a hardware device that includes a memory and a processor. The memory is configured to store program instructions, and the processor is configured to execute the program instructions to perform one or more processes which are described further below.

Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinbelow, exemplary embodiments of the present disclosure will be described in detail with reference to the accompanying drawings. Throughout the drawings, the same reference numerals will refer to the same or like parts.

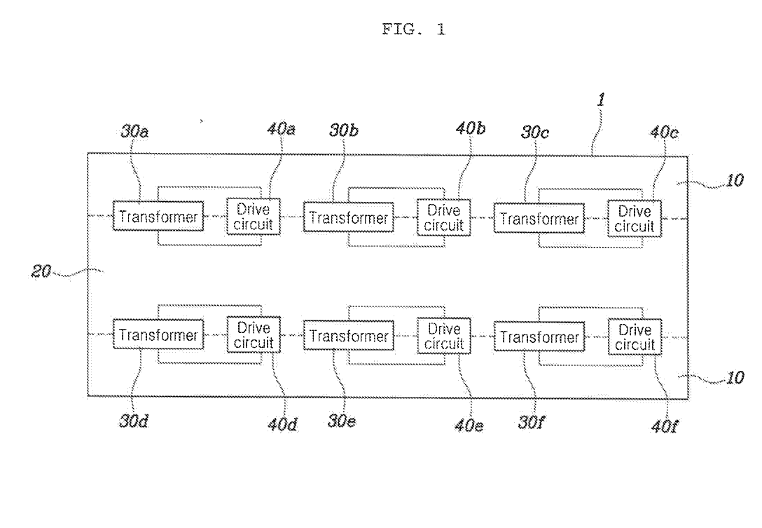

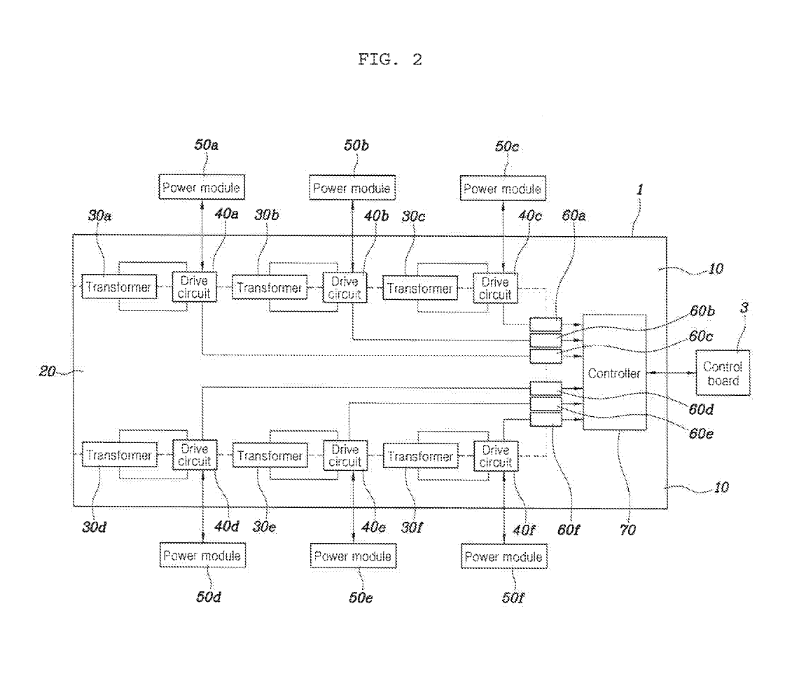

FIG. 1 is a schematic view showing an inverter gate board according to an embodiment of the present disclosure, and FIG. 2 is a block diagram showing a connection of the inverter gate board with an external board and modules according to an embodiment of the present disclosure.

The inverter gate board 1 is divided into a low-voltage region 20 and a high-voltage region 10, and includes: a plurality of drive circuits 40a, 40b, 40c, 40d, 40e, and 40f which are surface-mounted between the low-voltage region 20 and the high-voltage region 10 and each have a SMPS controller (not shown); a plurality of transformers 30a, 30b, 30c, 30d, 30e, and 30f which are surface-mounted between the low-voltage region 20 and the high-voltage region 10 so as to supply a transformed voltage to each of the drive circuits 40a to 40f, respectively; a controller 70 which is surface-mounted to the high-voltage region 10 and communicates with the drive circuits 40a to 40f and a control board 3; and an optical coupler 60a, 60b, 60c, 60d, 60e, and 60f which insulate the controller 70 from the low-voltage region 20.

The inverter gate board 1 includes the drive circuits 40a, 40b, 40c, 40d, 40e, and 40f which are surface-mounted between the high-voltage region 10 and the low-voltage region 20, and the transformers 30a, 30b, 30c, 30d, 30e, and 30f which supply boosted voltage to the drive circuits. Thus, an area of the low-voltage region 20 can be widely utilized. This further facilitates the patterning of a substrate and the reduction in size of the inverter gate board 1. Further, the high-voltage region 10 and the low-voltage region 20 are clearly divided, thereby improving insulating stability.

In the case of a conventional inverter gate board, since a single transformer boosts main power and supplies the boosted power to respective drive circuits, the transformer exists in the low-voltage region and a high-voltage trace exists in the low-voltage region in order to supply power to drive circuits on the side of the high-voltage region. Thus, a surface-mounting area is reduced and an insulating distance between the high-voltage region and the low-voltage region is required. However, according to the inverter gate board of the present disclosure, the transformers 30a to 30f are surface-mounted in proximity of corresponding drive circuits 40a to 40f so as to supply boosted drive voltages to corresponding drive circuits 40a to 40f. That is, an individual power supply circuit is configured for each drive circuit 40a to 40f.

With the configuration in which the transformers 30a to 30f are dispersed and arranged, heating of the transformers 30a to 30f and the power source (e.g., SMPS) can be reduced, an electromagnetic characteristic can be improved, and the transformers 30a to 30f can be reduced in size, thereby reducing vibration.

The drive circuits 40a to 40f can supply gate power to each of the individual power modules 50a, 50b, 50c, 50d, 50e, and 50f, respectively. The drive circuits 40a to 40f can receive information from corresponding power modules 50a to 50f and transmit the information to the controller 70.

The low-voltage region means a sub-battery voltage region for a vehicle, and the high-voltage region means a high-voltage battery region of a hybrid vehicle or an electric vehicle. The inverter gate board 1 may further include a power source (not shown) for the controller 70, and an insulating circuit (not shown). The controller 70 can communicate with the control board 3 and the drive circuits 40a to 40f. The drive circuits 40a to 40f can transmit information on high-voltage sensed by a voltage sensor, temperature, over-heat, over-voltage and the like of the power modules 50a to 50f to the controller 70. The communication may be performed by means of an SCI communication method.

Unlike the conventional configuration in which two individual inverter gate boards are typically required to drive two motors, in the case of the inverter gate board 1 according to the present disclosure, two 3-phase motors can be driven by a single board.

Although a preferred embodiment of the present disclosure has been described for illustrative purposes, those skilled in the art will appreciate that various modifications, additions and substitutions are possible, without departing from the scope and spirit of the disclosure as disclosed in the accompanying claims.

What is claimed is:

1. An inverter gate board divided into a low-voltage region and a high-voltage region, the inverter gate board comprising:
a plurality of drive circuits surface-mounted between the low-voltage region and the high-voltage region and each having a single main power source (SMPS) controller; and
a plurality of transformers surface-mounted between the low-voltage region and the high-voltage region so as to supply a transformed voltage to each of the plurality of drive circuits, respectively.

2. The inverter gate board according to claim 1, wherein the plurality of drive circuits supply a gate power to individual power modules.

3. The inverter gate board according to claim 2, further comprising a controller surface-mounted to the high-voltage region and communicating with the plurality of drive circuits and a control board, wherein the plurality of drive circuits receive information from the individual power modules and transmit the information to the controller.

4. The inverter gate board according to claim 3, further comprising an optical coupler to insulate the controller from the low-voltage region.
